(19) United States
(12) Patent Application Publication
(10) Pub. No.: US 2021/0252648 A1
(43) Pub. Date: Aug. 19, 2021

(54) Low-nickel Nitrogen-containing Austenitic Stainless Steel Flux-cored Wire and Preparation Method Thereof

(71) Applicant: Harbin Welding Institute Limited Company, Harbin (CN)

(72) Inventors: Naiwen Fang, Harbin (CN); Kai Xu, Harbin (CN); Kegui XU, Harbin (CN); Bo Chen, Harbin (CN); Yiming Ma, Harbin (CN); Yinan XU, Harbin (CN); Wanli QI, Harbin (CN)

(21) Appl. No.: 17/134,232

(22) Filed: Dec. 25, 2020

(30) Foreign Application Priority Data
Feb. 18, 2020 (CN) 202010100169X

(51) Int. Cl. B23K 35/02; B23K 35/368; B23K 35/30; C22C 38/58; C22C 38/44; C22C 38/42; C22C 38/02; C22C 38/00

(52) U.S. Cl. CPC B23K 35/0266; B23K 35/368; B23K 35/3086; C22C 38/002; C22C 38/44; C22C 38/42; C22C 38/02; C22C 38/58

(57) ABSTRACT

The disclosure provides a low-nickel nitrogen-containing austenitic stainless steel flux-cored wire and a preparation method thereof, and belongs to the technical field of welding materials. The disclosure aims at solving the technical problems of nitrogen element loss, air holes, hot cracks in a welding seam area, and pitting corrosion caused by nitride precipitation in a heat affected area that are easily generated in a welding joint when low-nickel nitrogen-containing austenitic stainless steel is welded in the prior art. The flux-cored wire of the disclosure is prepared from a flux core and a stainless steel sheath. During welding, gas protection is not needed. The flux core is formed by mixing an alloy component and a slag system. The alloy component is formed by mixing electrolytic manganese, ferrosilicon, chromium metal, nickel metal, ferromolybdenum, copper powder and ferrochrome nitride powder in percentage by mass. The slag system is formed by mixing complex fluoride, a carbonate mixture, potassium feldspar, rutile, zircon sand and Al—Mg alloy in percentage by mass. The method includes: mixing the alloy component and the slag system, filling the mixture into the stainless steel sheath, and performing drawing and diameter reduction to obtain the low-nickel nitrogen-containing austenitic stainless steel flux-cored wire.

### TECHNICAL FIELD

The disclosure belongs to the technical field of welding materials, and particularly relates to a low-nickel nitrogen-containing austenitic stainless steel flux-cored wire and a preparation method thereof.

### BACKGROUND

Low-nickel nitrogen-containing austenitic stainless steel mainly utilizes a nitrogen element to partially or even completely replace an alloy element of nickel to obtain a single-phase austenite structure. Alloying by utilizing nitrogen has many advantages, for example, compared with carbon, nitrogen is a more effective solid solution strengthening element, and can promote grain refinement at the same time; nitrogen is a strong austenite forming element, and can reduce the nickel content and reduce the forming opportunity of ferrite and deformation martensite, and nitrogen can greatly improve pitting corrosion resistance of a material.

The low-nickel nitrogen-containing austenitic stainless steel has good plasticity, corrosion resistance and high-temperature resistance, and is thus widely applied to the industries of ships, aviation, chemical industry, petroleum containers and the like. However, when low-nickel nitrogen-containing austenitic stainless steel is welded by utilizing a conventional stainless steel welding rod, the problems of nitrogen element loss, air holes, hot cracks in a welding seam area, pitting corrosion caused by nitride precipitation in a heat affected area and the like are easily generated in a welding joint, and the low-temperature impact toughness is low, so that the popularization and application of the low-nickel nitrogen-containing austenitic stainless steel are further limited. Therefore, the research and development of a matched welding wire has great significance for improving the applicability of the welding process of the low-nickel nitrogen-containing austenitic stainless steel and improving the low-temperature impact toughness and pitting corrosion resistance of the welding joint.

### SUMMARY

The disclosure is directed to solve the technical problems of nitrogen element loss, air holes, hot cracks in a welding seam area, pitting corrosion caused by nitride precipitation in a heat affected area that are easily generated in a welding joint when low-nickel nitrogen-containing austenitic stainless steel is welded in the prior art, and provides a low-nickel nitrogen-containing austenitic stainless steel flux-cored wire and a preparation method thereof.

The low-nickel nitrogen-containing austenitic stainless steel flux-cored wire of the disclosure is prepared from a flux core and a stainless steel sheath. During welding, gas protection is not needed.

The flux core is formed by mixing an alloy component and a slag system. The sum of the mass percentage of all components in the flux core is 100%.

The alloy component is formed by mixing 26%-30% of electrolytic manganese, 1%-3% of ferrosilicon, 14%-21% of chromium metal, 9%-14% of nickel metal, 0%-1% of ferromolybdenum, 5%-10% of copper powder and 4%-9% of ferrochrome nitride powder in percentage by mass.

The slag system is formed by mixing 5%-12% of complex fluoride, 1%-5% of a carbonate mixture, 1%-10% of potassium feldspar, 10%-35% of rutile, 1%-2% of zircon sand and 1%-4% of Al—Mg alloy in percentage by mass.

Further defined, the complex fluoride is formed by mixing barium fluoride, sodium fluoride, magnesium fluoride and calcium fluoride according to the mass ratio of 6:1:3:10.

Further defined, the carbonate mixture is formed by mixing sodium carbonate, calcium carbonate and lithium carbonate according to the mass ratio of 2:6:1.

Further defined, the nitrogen content of the ferrochrome nitride powder is 6-8%.

Further defined, the stainless steel sheath is a 430 stainless steel band, and impurity elements and the mass percentage in the 430 stainless steel band are as follows: P≤0.045%, and S≤0.03%.

Further defined, the particle size of all the components in the flux core is 80-200 meshes.

The preparation method of the low-nickel nitrogen-containing austenitic stainless steel flux-cored wire is performed according to the following steps:

1. performing high-temperature baking on rutile and potassium feldspar for later use;

2. mixing calcium fluoride, sodium fluoride, barium fluoride and magnesium fluoride to obtain complex fluoride, and performing high-temperature baking for later use;

3. weighing electrolytic manganese, ferrosilicon, chromium metal, nickel metal, ferromolybdenum, copper powder, ferrochrome nitride powder, the complex fluoride obtained in step 2, a carbonate mixture, the potassium feldspar and the rutile obtained in step 1, zircon sand and Al—Mg alloy according to the ratio of components of a flux core, performing mixing after sieving, and then performing low-temperature drying to obtain the flux core; and

4. filling the flux core obtained in step 3 into a stainless steel sheath, and performing drawing and diameter reduction to obtain the low-nickel nitrogen-containing austenitic stainless steel flux-cored wire.

Further defined, high-temperature baking parameters in step 1 are as follows: the temperature is 800-1000° C., and the time is 50 min-70 min.

Further defined, the particle size of the rutile and the potassium feldspar is 80-200 meshes.

Further defined, high-temperature baking parameters in step 2 are as follows: the temperature is 750-950° C., and the time is 50 min-70 min.

Further defined, the particle size of the calcium fluoride, the sodium fluoride, the barium fluoride and the magnesium fluoride in step 2 is 100-200 meshes.

Further defined, the sieving in step 3 refers to sieving by an 80-mesh sieve.

Further defined, low-temperature drying parameters in step 3 are as follows: the temperature is 100° C., and the time is 50 min-60 min.

The low-nickel nitrogen-containing austenitic stainless steel flux-cored wire of the disclosure mainly utilizes the nitrogen element to partially replace the alloy element of nickel to obtain a single-phase austenite structure. When the novel low-nickel austenitic stainless steel is welded, a large amount of nickel resources can be saved by the low-nickel nitrogen-containing austenitic stainless steel welding rod, because it utilizes nitrogen for alloying. By utilizing the low-nickel nitrogen-containing austenitic stainless steel flux-cored wire of the disclosure for welding, the tensile strength of the welding joint can reach 677 MPa, the elongation at break can reach 37%, the comprehensive performance is excellent, and its application in industries of ships, aviation, chemical industry, petroleum containers and the like is wide.

### DETAILED DESCRIPTION

Specific embodiment 1: A low-nickel nitrogen-containing austenitic stainless steel flux-cored wire in the present embodiment was prepared from a flux core and a stainless steel sheath (an SUS430 stainless steel band with the width of 9.8 mm and the thickness of 0.4 mm), and during welding, gas protection was not needed.

The flux core was formed by mixing an alloy component and a slag system, and the sum of the mass percentage of all components in the flux core was 100%.

The alloy component was formed by mixing 28% of electrolytic manganese, 2.5% of ferrosilicon, 16% of chromium metal, 12.5% of nickel metal, 0.8% of ferromolybdenum, 8.5% of copper powder and 6% of ferrochrome nitride powder in percentage by mass.

The slag system was formed by mixing 5% of complex fluoride, 3% of a carbonate mixture, 2% of potassium feldspar, 10.7% of rutile, 2% of zircon sand and 3% of Al—Mg alloy in percentage by mass.

The complex fluoride was formed by mixing barium fluoride, sodium fluoride, magnesium fluoride and calcium fluoride according to the mass ratio of 6:1:3:10.

The carbonate mixture was formed by mixing sodium carbonate, calcium carbonate and lithium carbonate according to the mass ratio of 2:6:1.

The nitrogen content of the ferrochrome nitride powder was 8%.

The particle size of all the components in the flux core was 80-200 meshes.

A preparation method was performed according to the following steps:

1. Rutile and potassium feldspar were subjected to high-temperature baking at 900° C. for 60 min for later use.

2. Complex fluoride was obtained by mixing calcium fluoride, sodium fluoride, barium fluoride and magnesium fluoride, and was subjected to high-temperature baking at 850° C. for 60 min for later use.

3. Electrolytic manganese, ferrosilicon, chromium metal, nickel metal, ferromolybdenum, copper powder, ferrochrome nitride powder, the complex fluoride obtained in step 2, a carbonate mixture, the potassium feldspar and the rutile obtained in step 1, zircon sand and Al—Mg alloy were weighed according to the ratio of components of a flux core, mixing was performed after sieving, and then low-temperature drying was performed at 100° C. for 60 min to obtain the flux core.

4. Firstly, the SUS430 stainless steel band with the width of 9.8 mm and the thickness of 0.4 mm was rolled into a U shape; then, the flux core obtained in step 3 was added into the U-shaped groove; next, an opening of the U-shaped groove was closed so that the flux core powder was compactly rolled, the filling rate was 24%, and the low-nickel nitrogen-containing austenitic stainless steel flux-cored wire with the diameter of 1.6 mm was obtained after drawing and diameter reduction.

Specific embodiment 2: A low-nickel nitrogen-containing austenitic stainless steel flux-cored wire in the present embodiment was prepared from a flux core and a stainless steel sheath (an SUS430 stainless steel band with the width of 9.8 mm and the thickness of 0.4 mm), and during welding, gas protection was not needed.

The flux core was formed by mixing an alloy component and a slag system, and the sum of the mass percentage of all components in the flux core was 100%.

The alloy component was formed by mixing 28% of electrolytic manganese, 2.5% of ferrosilicon, 15% of chromium metal, 12.2% of nickel metal, 0.8% of ferromolybdenum, 8.5% of copper powder and 7% of ferrochrome nitride powder in percentage by mass.

The slag system was formed by mixing 6% of complex fluoride, 2% of a carbonate mixture, 2% of potassium feldspar, 11% of rutile, 2% of zircon sand and 3% of Al—Mg alloy in percentage by mass.

The complex fluoride was formed by mixing barium fluoride, sodium fluoride, magnesium fluoride and calcium fluoride according to the mass ratio of 6:1:3:10.

The carbonate mixture was formed by mixing sodium carbonate, calcium carbonate and lithium carbonate according to the mass ratio of 2:6:1.

The nitrogen content of the ferrochrome nitride powder was 8%.

The particle size of all the components in the flux core was 80-200 meshes.

A preparation method was performed according to the following steps:

1. Rutile and potassium feldspar were subjected to high-temperature baking at 900° C. for 60 min for later use.

2. Complex fluoride was obtained by mixing calcium fluoride, sodium fluoride, barium fluoride and magnesium fluoride, and was subjected to high-temperature baking at 850° C. for 60 min for later use.

3. Electrolytic manganese, ferrosilicon, chromium metal, nickel metal, ferromolybdenum, copper powder, ferrochrome nitride powder, the complex fluoride obtained in step 2, a carbonate mixture, the potassium feldspar and the rutile obtained in step 1, zircon sand and Al—Mg alloy were weighed according to the ratio of components of a flux core, mixing was performed after sieving, and then low-temperature drying was performed at 100° C. for 60 min to obtain the flux core.

4. Firstly, the SUS430 stainless steel band with the width of 9.8 mm and the thickness of 0.4 mm was rolled into a U shape; then, the flux core obtained in step 3 was added into the U-shaped groove; next, an opening of the U-shaped groove was closed so that the flux core powder was compactly rolled, the filling rate was 24%, and the low-nickel nitrogen-containing austenitic stainless steel flux-cored wire with the diameter of 1.6 mm was obtained after drawing and diameter reduction.

Specific embodiment 3: A low-nickel nitrogen-containing austenitic stainless steel flux-cored wire in the present embodiment was prepared from a flux core and a stainless steel sheath (an SUS430 stainless steel band with the width of 9.8 mm and the thickness of 0.4 mm), and during welding, gas protection was not needed.

The flux core was formed by mixing an alloy component and a slag system, and the sum of the mass percentage of all components in the flux core was 100%.

The alloy component was formed by mixing 28% of electrolytic manganese, 2.5% of ferrosilicon, 14% of chromium metal, 12.2% of nickel metal, 0.8% of ferromolybdenum, 8.5% of copper powder and 8% of ferrochrome nitride powder in percentage by mass.

The slag system was formed by mixing 7% of complex fluoride, 1% of a carbonate mixture, 2% of potassium feldspar, 12% of rutile, 2% of zircon sand and 2% of Al—Mg alloy in percentage by mass.

The complex fluoride was formed by mixing barium fluoride, sodium fluoride, magnesium fluoride and calcium fluoride according to the mass ratio of 6:1:3:10.

The carbonate mixture was formed by mixing sodium carbonate, calcium carbonate and lithium carbonate according to the mass ratio of 2:6:1.

The nitrogen content of the ferrochrome nitride powder was 8%.

The particle size of all the components in the flux core was 80-200 meshes.

Impurity elements and the mass percentage in the SUS430 stainless steel band were as follows: P≤0.045%, and S≤0.03%.

A preparation method was performed according to the following steps:

1. Rutile and potassium feldspar were subjected to high-temperature baking at 900° C. for 60 min for later use.

2. Complex fluoride was obtained by mixing calcium fluoride, sodium fluoride, barium fluoride and magnesium fluoride, and was subjected to high-temperature baking at 850° C. for 60 min for later use.

3. Electrolytic manganese, ferrosilicon, chromium metal, nickel metal, ferromolybdenum, copper powder, ferrochrome nitride powder, the complex fluoride obtained in step 2, a carbonate mixture, the potassium feldspar and the rutile obtained in step 1, zircon sand and Al—Mg alloy were weighed according to the ratio of components of a flux core, mixing was performed after sieving, and then low-temperature drying was performed at 100° C. for 60 min to obtain the flux core.

4. Firstly, the SUS430 stainless steel band with the width of 9.8 mm and the thickness of 0.4 mm was rolled into a U shape; then, the flux core obtained in step 3 was added into the U-shaped groove; next, an opening of the U-shaped groove was closed so that the flux core powder was compactly rolled, the filling rate was 24%, and the low-nickel nitrogen-containing austenitic stainless steel flux-cored wire with the diameter of 1.6 mm was obtained after drawing and diameter reduction.

Specific embodiment 4: A low-nickel nitrogen-containing austenitic stainless steel flux-cored wire in the present embodiment was prepared from a flux core and a stainless steel sheath (an SUS430 stainless steel band with the width of 9.8 mm and the thickness of 0.4 mm), and during welding, gas protection was not needed.

The flux core was formed by mixing an alloy component and a slag system, and the sum of the mass percentage of all components in the flux core was 100%.

The alloy component was formed by mixing 29% of electrolytic manganese, 2.5% of ferrosilicon, 20% of chromium metal, 9.5% of nickel metal, 6.5% of copper powder and 8% of ferrochrome nitride powder in percentage by mass.

The slag system was formed by mixing 6% of complex fluoride, 1% of a carbonate mixture, 2% of potassium feldspar, 13.5% of rutile, 1% of zircon sand and 1% of Al—Mg alloy in percentage by mass.

The complex fluoride was formed by mixing barium fluoride, sodium fluoride, magnesium fluoride and calcium fluoride according to the mass ratio of 6:1:3:10.

The carbonate mixture was formed by mixing sodium carbonate, calcium carbonate and lithium carbonate according to the mass ratio of 2:6:1.

The nitrogen content of the ferrochrome nitride powder was 8%.

The particle size of all the components in the flux core was 80-200 meshes.

Impurity elements and the mass percentage in the SUS430 stainless steel band were as follows: P≤0.045%, and S≤0.03%.

A preparation method was performed according to the following steps:

1. Rutile and potassium feldspar were subjected to high-temperature baking at 950° C. for 60 min for later use.

2. Complex fluoride was obtained by mixing calcium fluoride, sodium fluoride, barium fluoride and magnesium fluoride, and was subjected to high-temperature baking at 780° C. for 60 min for later use.

3. Electrolytic manganese, ferrosilicon, chromium metal, nickel metal, copper powder, ferrochrome nitride powder, the complex fluoride obtained in step 2, a carbonate mixture, the potassium feldspar and the rutile obtained in step 1, zircon sand and Al—Mg alloy were weighed according to the ratio of components of a flux core, mixing was performed after sieving, and then low-temperature drying was performed at 100° C. for 60 min to obtain the flux core.

4. Firstly, the SUS430 stainless steel band with the width of 9.8 mm and the thickness of 0.4 mm was rolled into a U shape; then, the flux core obtained in step 3 was added into the U-shaped groove; next, an opening of the U-shaped groove was closed so that the flux core powder was compactly rolled, the filling rate was 24%, and the low-nickel nitrogen-containing austenitic stainless steel flux-cored wire with the diameter of 1.6 mm was obtained after drawing and diameter reduction.

Specific embodiment 5: A low-nickel nitrogen-containing austenitic stainless steel flux-cored wire in the present embodiment was prepared from a flux core and a stainless steel sheath (an SUS430 stainless steel band with the width of 9.8 mm and the thickness of 0.4 mm), and during welding, gas protection was not needed.

The flux core was formed by mixing an alloy component and a slag system, and the sum of the mass percentage of all components in the flux core was 100%.

The alloy component was formed by mixing 28% of electrolytic manganese, 2.5% of ferrosilicon, 19% of chromium metal, 12.2% of nickel metal, 1% of ferromolybdenum, 6.3% of copper powder and 9% of ferrochrome nitride powder in percentage by mass.

The slag system was formed by mixing 5% of complex fluoride, 1% of a carbonate mixture, 1% of potassium feldspar, 12% of rutile, 1% of zircon sand and 2% of Al—Mg alloy in percentage by mass.

The complex fluoride was formed by mixing barium fluoride, sodium fluoride, magnesium fluoride and calcium fluoride according to the mass ratio of 6:1:3:10.

The carbonate mixture was formed by mixing sodium carbonate, calcium carbonate and lithium carbonate according to the mass ratio of 2:6:1.

The nitrogen content of the ferrochrome nitride powder was 8%.

The particle size of all the components in the flux core was 80-200 meshes.

Impurity elements and the mass percentage in the SUS430 stainless steel band were as follows: P≤0.045%, and S≤0.03%.

A preparation method was performed according to the following steps:

1. Rutile and potassium feldspar were subjected to high-temperature baking at 850° C. for 60 min for later use.

2. Complex fluoride was obtained by mixing calcium fluoride, sodium fluoride, barium fluoride and magnesium fluoride, and was subjected to high-temperature baking at 900° C. for 60 min for later use.

3. Electrolytic manganese, ferrosilicon, chromium metal, nickel metal, ferromolybdenum, copper powder, ferrochrome nitride powder, the complex fluoride obtained in step 2, a carbonate mixture, the potassium feldspar and the rutile obtained in step 1, zircon sand and Al—Mg alloy were weighed according to the ratio of components of a flux core, mixing was performed after sieving, and then low-temperature drying was performed at 100° C. for 60 min to obtain the flux core.

4. Firstly, the SUS430 stainless steel band with the width of 9.8 mm and the thickness of 0.4 mm was rolled into a U shape; then, the flux core obtained in step 3 was added into the U-shaped groove; next, an opening of the U-shaped groove was closed so that the flux core powder was compactly rolled, the filling rate was 24%, and the low-nickel nitrogen-containing austenitic stainless steel flux-cored wire with the diameter of 1.6 mm was obtained after drawing and diameter reduction.

Inspection Test

1. Chemical components of the low-nickel nitrogen-containing austenitic stainless steel flux-cored wires in Specific embodiments 1-5 were inspected, and chemical components of flux-cored wire deposited metal were obtained as shown in Table 1.

TABLE 1
Chemical components of flux-cored wire deposited metal

| Specific | Chemical components (Wt %) | | | | | | | | | | |
|---|---|---|---|---|---|---|---|---|---|---|---|
| embodiment | C | Cr | Ni | Si | Mn | Mo | N | Cu | S | P | Fe |
| 1 | 0.024 | 18.5 | 2.6 | 0.42 | 6.42 | 0.1 | 0.087 | 1.81 | ≤0.03 | ≤0.04 | The balance |
| 2 | 0.023 | 18.3 | 2.56 | 0.41 | 6.40 | 0.012 | 0.11 | 1.82 | ≤0.03 | ≤0.04 | The balance |
| 3 | 0.024 | 18.1 | 2.57 | 0.4 | 6.39 | 0.09 | 0.13 | 1.84 | ≤0.03 | ≤0.04 | The balance |
| 4 | 0.2 | 19.2 | 2.1 | 0.4 | 6.82 | 0.01 | 0.14 | 1.49 | ≤0.03 | ≤0.04 | The balance |
| 5 | 0.025 | 19 | 2.16 | 0.38 | 6.21 | 0.11 | 0.145 | 1.53 | ≤0.03 | ≤0.04 | The balance |

2. The low-nickel nitrogen-containing austenitic stainless steel flux-cored wires in Specific embodiments 1-5 were utilized for welding, then, welding joints were subjected to mechanical property inspection, and mechanical property values of the welding joints were obtained as shown in Table 2.

TABLE 2
Mechanical property of welding joints

| | | | Tensile | |
|---|---|---|---|---|
| | Welding | Welding | strength | |
| Welding method | current A | voltage V | Mpa | Elongation % |
| Specific | 180-220 | 26-28 | 651 | 38 |
| embodiment 1 | | | | |
| Specific | 180-220 | 26-28 | 637 | 41 |
| embodiment 2 | | | | |
| Specific | 180-220 | 26-28 | 625 | 45 |
| embodiment 3 | | | | |
| Specific | 180-220 | 26-28 | 603 | 51 |
| embodiment 4 | | | | |
| Specific | 180-220 | 26-28 | 677 | 37 |
| embodiment 5 | | | | |

1. A low-nickel nitrogen-containing austenitic stainless steel flux-cored wire, wherein:
the low-nickel nitrogen-containing austenitic stainless steel flux-cored wire comprises a flux core and a stainless steel sheath;
the flux core is formed by mixing an alloy component and a slag system;
the alloy component is formed by mixing 26% to 30% of electrolytic manganese, 1% to 3% of ferrosilicon, 14% to 21% of chromium metal, 9% to 14% of nickel metal, 0% to 1% of ferromolybdenum, 5% to 10% of copper powder, and 4% to 9% of ferrochrome nitride powder in percentage by mass; and
the slag system is formed by mixing 5% to 12% of complex fluoride, 1% to 5% of a carbonate mixture, 1% to 10% of potassium feldspar, 10% to 35% of rutile, 1% to 2% of zircon sand, and 1% to 4% of Al—Mg alloy in percentage by mass;
the complex fluoride is formed by mixing barium fluoride, sodium fluoride, magnesium fluoride, and calcium fluoride according to a mass ratio of 6:1:3:10;
the carbonate mixture is formed by mixing sodium carbonate, calcium carbonate, and lithium carbonate according to a mass ratio of 2:6:1; and
the stainless steel sheath is a 430 stainless steel band, and gas protection is not needed during welding of the flux-cored wire.

2. The low-nickel nitrogen-containing austenitic stainless steel flux-cored wire according to claim 1, wherein the nitrogen content of the ferrochrome nitride powder is 6% to 8%.

3. The low-nickel nitrogen-containing austenitic stainless steel flux-cored wire according to claim 1, wherein the particle size of all components in the flux core is 80 to 200 meshes.

4. A method of preparing a low-nickel nitrogen-containing austenitic stainless steel flux-cored wire, which comprises:
(a) baking rutile and potassium feldspar at 800° C. to 1000° C., for 50 minutes to 70 minutes;
(b) mixing calcium fluoride, sodium fluoride, barium fluoride, and magnesium fluoride to obtain complex fluoride;
(c) baking the mixture at 750° C. to 950° C., for 50 minutes to 70 minutes;
(d) weighing electrolytic manganese, ferrosilicon, chromium metal, nickel metal, ferromolybdenum, copper powder, ferrochrome nitride powder, the complex fluoride obtained in (b), a carbonate mixture, the potassium feldspar and the rutile obtained in (a), zircon sand, and Al—Mg alloy according to the ratio of components of a flux core;
(e) mixing after sieving the mixture of (d);
(f) drying the resultant mixture to obtain a flux core at 100° C., for 50 minutes to 60 minutes; and
(g) filling the flux core obtained in (f) into a stainless steel sheath, and performing drawing and diameter reduction to obtain the low-nickel nitrogen-containing austenitic stainless steel flux-cored wire.
